(19) United States
(12) Patent Application Publication
(10) Pub. No.: US 2007/0198536 A1
(43) Pub. Date: Aug. 23, 2007

(54) Data access

(76) Inventors: Michael G. Coutts, Dundee (GB); Iain R.F. Sime, Kirriemuir (GB); Ross W. Duncan, Blairgowrie (GB); Timothy Wiggins, Inchture (GB)

Correspondence Address: MICHAEL CHAN;NCR CORPORATION, 1700 SOUTH PATTERSON BLVD, DAYTON, OH, 45479-0001, US

(21) Appl. No.: 11/786,650

(22) Filed: Apr. 12, 2007

Related U.S. Application Data
(62) Division of application No. 09/952,697, filed on Sep. 14, 2001.

(30) Foreign Application Priority Data
Sep. 19, 2000 (GB) 0022970.8

(51) Int. Cl. G06F 17/30

(52) U.S. Cl. 707/10

(57) ABSTRACT

A data brokerage system (12) is described. The system comprises: a database (18) for storing a plurality of data accounts; a data update interface (24); and a data sales interface (26) for allowing a third party to query preselected data accounts. Each data account includes data associated with an individual and access rights selected by the individual. The data update interface (24) allows an individual to add data to their data account. The system (12) is able to charge a third party a fee for accessing data accounts meeting an acceptance criteria. A method of selling access to data in a database is also described. The method comprises the steps of: storing data associated with an individual (100); allowing the individual to determine access rights to the data (124); and selling access to the data to a third party (106).

This application is a divisional application of co-pending application Ser. No. 09/952,697 filed Sep. 14, 2001.

### BACKGROUND OF THE INVENTION

The present invention relates to data access. In particular, the invention relates to a method of selling access to data, such as data stored in a data warehouse.

Data warehouses are large intelligent data storage systems that can store vast amounts of data received from a variety of sources in a safe and secure manner, and that allow users to interrogate the stored data.

Data warehouses are used by most large businesses (such as major retailers and financial institutions) to store transaction information, inventory information, and such like. These businesses use the data warehouse to increase their understanding of their customers and thereby to target more accurately products and services to their customers.

Through mechanisms such as loyalty schemes and transaction records these businesses build up extensive data relating to the products and services individual people purchase and use. This data is stored in a data warehouse and can be mined to identify groups of prospective customers for new products and services that the businesses might wish to introduce.

Using this data to target products and services towards individuals or groups of customers will increase the revenue of the business by increasing the customer's propensity to spend money on those products and services.

Although this is of great benefit to the businesses who use this data, the customer actually gets little or nothing from the use of their data by these businesses, except the opportunity to spend more on new products and services. Loyalty schemes are one method of gathering this data, but these schemes provide marginal benefit to the customer (typically, a customer may obtain a one percent saving for his/her loyalty to an individual retailer) and the customer has the inconvenience of either being tied to a single retailer or having to enroll in multiple schemes and carry multiple identifiers.

From the perspective of the businesses, each individual business can only ever have an incomplete record of the customer's data: each business only has a slice of information about the customer. They can only acquire information directly associated with their individual dealings with the customer, and data protection laws typically prohibit the unauthorized transfer of personal information between businesses and even between different sections of the same business. For example, a retailer who also provides financial services is not allowed to pass data between the two segments (retail and financial) of the business without authorization from the customer. Therefore individual businesses can only ever have an incomplete record of their customers' buying habits. Individual financial institutions do not know what use will be made of funds transferred from their accounts, thereby reducing their ability to develop and offer appropriate financial products and services for their customers.

Thus, neither the businesses nor the customers actually maximize the use of the available information. Individual businesses have to operate with incomplete information for each customer; and the customer gets little benefit from the data that is captured about his/her spending habits, bank transactions, and such like.

### SUMMARY OF THE INVENTION

It is among the objects of an embodiment of the invention to obviate or mitigate one or more of the above disadvantages, or other disadvantages associated with data collection and storage.

According to a first aspect of the present invention there is provided a method of selling access to data, the method comprising the steps of: storing data associated with an individual; allowing the individual to determine access rights to the data; and selling access to the data to a third party.

Preferably, the step of storing data associated with an individual involves the step of storing data in a database comprising data relating to a plurality of individuals. In one embodiment, the database may store data relating to one thousand or more individuals.

Preferably, the data associated with an individual includes data relating to one or more of the individual's: name, address, age, gender, assets (such as house, car, and such like), liabilities (mortgage, loan, and such like), transactions (withdrawals, credit card payments, and such like), receipts (such as for food, clothing, hardware, services), and such like.

Preferably, the method includes the further step of updating the stored data with new data relating to activities and/or events associated with the individual. This ensures that the stored data is up to date.

The step of allowing the individual to determine access rights to the data, may include:

(1) allowing all the data to be accessed by another party;

(2) allowing only a portion of the data to be accessed by a third party, for example, the data may be anonymized (made anonymous);

(3) not allowing any of the data to be accessed by a third party.

The step of selling access to the data to a third party may be implemented by a broker.

The broker may be, for example, a company, a person, or software (such as an intelligent agent or a rules engine).

The step of selling access to the data to a third party may include the steps of: informing the individual of a request for data; and, in response to the individual agreeing to the sale, selling access to the data.

The step of informing the individual of a request for data may be implemented using an electronic delivery channel, for example, email, cellular telephone, SMS, or such like.

The step of selling access to the data to a third party may include the steps of: executing a query on the database for a third party; and charging the third party for the results of this query.

An individual may be charged a lower rate for storing his/her data if the individual is willing to make at least a minimum amount of data available to third parties. For example, an individual who is only willing to grant access to his age and gender may be charged more than an individual who is willing to grant access to all his data except his name and street address.

By virtue of this aspect of the invention an individual is able to collate and store a huge variety of information relating to him/herself, and to allow a third party (such as a large business) to access the data. The individual is able to determine what data the third party can access. This allows the third party to obtain more information about an individual than the slice of information it may store on its own database relating to the individual.

According to a second aspect of the present invention there is provided a method of storing personal data, the method comprising the steps of: transmitting personal data to a remote data warehouse to initiate a data storage account; updating on an on-going basis the data storage account with new personal data relating to financial and retail transactions; selecting access rights to the data storage account, so that a third party can pay for access to data defined by the access rights.

The method may include the further step of allowing a query to be executed on a portion of the stored data to which access is granted.

According to a third aspect of the present invention there is provided a method of organizing a data warehouse, the method comprising the steps of: renting a portion of the data warehouse to an individual; allowing the individual to store data in the data warehouse; allowing the individual to select access rights to the individual's stored data, so that a third party can access the stored data according to the selected access rights.

The step of renting a portion of the data warehouse to an individual may include: charging a fixed fee for a period as rent; or charging a fee per query as rent.

According to a fourth aspect of the present invention there is provided a data brokerage system, the system comprising: a database for storing a plurality of data accounts, where each data account includes data associated with an individual and access rights selected by the individual; a data update interface for allowing an individual to add data to their data account; and a data sales interface for allowing a third party to query preselected data accounts; whereby a third party is charged a fee for accessing data accounts.

The database may be implemented by a data warehouse. The data update interface may be implemented as an application executing on a data warehouse. Similarly, the data sales interface may be implemented as an application executing on a data warehouse. The data update interface and data sales interface may be implemented by a single application. In addition, a client data update interface may be provided for local execution on a computing device (such as a personal computer, a personal digital assistant, a cellular telephone, or such like); and a client data sales interface may be provided for local execution by a third party on a computing device. The client interface may be implemented by Web pages performing some local processing; for example, including Applets (trade mark) to process fields in a Web page prior to sending the Web page back to a server application.

The client data update interface may automatically transfer data to the data update interface. For example, an ATM may have an associated client update interface that automatically sends transaction information to the database. The client data update interface may allow a user to update data as and when required. For example, a user may transfer an electronic receipt after returning from a shopping trip.

It will be appreciated that a third party is only allowed to access data in data accounts meeting an acceptance criteria. The acceptance criteria includes the account having an access right that is consistent with the access requested by the third party, and may also include any parameters requested by the third party. For example, these parameters may include: only males, only individuals between the ages of 18 and 21 years, only car owners, only those individuals who have shopped at a particular retail outlet in the last week, or such like.

The database may store agents (such as intelligent software agents) that perform functions for each individual. Hereinafter, these agents will be referred to as consumer agents. The agents may be static or mobile.

Preferably, a consumer agent uses the data stored in a data account to assist it in performing these functions, which may include: planning purchases (for example, shopping lists, servicing a car, or such like), obtaining quotations (for example, for a loan, a mortgage, renewing car insurance, or such like), advising on investments, reminding the individual about forthcoming events (such as birthdays, anniversaries, and such like), and other such functions.

Preferably, a consumer agent is able to advertise the type of individual that it represents (for example, young male, car owner, with a family) and the depth of information that the individual is willing to divulge (that is, the extent of the access rights) to attract third parties to request the data. One advantage of using a consumer agent is that a consumer agent may be used to answer queries posed by the third party, thereby avoiding the third party having direct access to the database. This avoids the underlying data being revealed or left open to misuse.

The database may also store its own intelligent software agent (hereinafter referred to as a broker agent) for selling data stored in the database.

A third party may have its own agent (hereinafter referred to as a business agent) so that the third party can instruct the broker agent about the number and type of individuals that the third party would like to query. The business agent may then interact with the broker agent and/or directly with one or more consumer agents.

Business agents may pay a fee per query posed so that if they want to find out further information they must pay a further fee, rather than being able to acquire their own copy of the data on which they could execute multiple queries free of charge.

If a business agent wants to negotiate for more information than the consumer agent is authorized to release then the consumer agent can ask the individual for permission. The individual may grant permission, depending on the incentive that the business agent offers. The consumer agent and the business agent may have already negotiated an incentive that is likely to be acceptable to both sides, so that the individual is only asked to sanction any preliminary agreement that the agents have reached.

The fee charged may be split between the owner of the data warehouse and the individuals whose accounts have been accessed. Alternatively, the fee may be retained by the owner of the data warehouse in lieu of any rental charge. In other embodiments, the individual may retain the fee and may pay a fixed rental charge to the data warehouse owner.

The data warehouse may comprise a relational database management system (RDBMS), an object database management system (ODBMS), or an object relational database management system (ORDBMS). Suitable data warehouses are available from major data warehouse vendors such as NCR (trade mark), and include TOR (trade mark) and Teradata (trade mark) database systems.

By virtue of this aspect of the invention, a customer is able to aggregate all his/her information and sell access to that information to a third party, such as a business.

According to a fifth aspect of the present invention there is provided a data agent, the agent comprising: means for accessing a database storing a data account associated with an individual; means for storing access rights selected by the individual; means for notifying potential buyers about data that is available for accessing by the potential buyer; and means for allowing a third party to query preselected data in return for payment.

According to a sixth aspect of the present invention there is provided a lifestyle agent, the agent comprising: means for accessing a database storing data associated with an individual; means for predicting an item that a user may require; means for identifying businesses that may provide this item; and means for obtaining pricing information from a plurality of these businesses to enable the user to conclude a transaction for this item.

The item may be a goods item (such as a grocery item), or a service item (such as car insurance).

Preferably, the lifestyle agent predicts an item that may be required by the user by examining the stored data associated with the individual. For example, the stored data may indicate that the user's car insurance policy is due for renewal.

Preferably, the lifestyle agent uses the data stored in the database to obtain pricing information. Thus, the agent may provide an insurance company with the user's personal details to enable the insurance company to give the agent an accurate quotation for insurance.

According to a seventh aspect of the present invention there is provided a lifestyle agent, the agent comprising: means for accessing a database storing data associated with an individual; means for processing this data to determine a potential user requirement; means for identifying businesses that may be capable of fulfilling the potential user requirement; and means for notifying the individual about information relating to the potential user requirement.

The database may provide the individual with the lifestyle agent, and may charge the individual a fee for using this agent. The fee may be charged as a fixed periodic rate, or on a per use basis.

According to an eighth aspect of the present invention there is provided an asset agent, the agent comprising: means for accessing a database storing data associated with an individual; means for receiving a request from the individual for a new asset; means for processing the stored data to determine boundaries of the individual; means for identifying vendors that may be capable of fulfilling the asset request; and means for notifying the individual about information relating to the asset request.

The boundaries may include, for example, the individual's income, the individual's disposable income, the size of house, garden, garage, or such like, occupied by the individual.

The new asset may also be used to determine additional costs, for example, where the new asset is car, the agent may also obtain car insurance quotations based on the individual owning the car.

### BRIEF DESCRIPTION OF THE DRAWINGS

These and other aspects of the present invention will be apparent from the following specific description, given by way of example, with reference to the accompanying drawings, in which:

FIG. 1 is a simplified block diagram of a data collection, storage, and retrieval system according to one embodiment of the present invention;

FIG. 2 is a process flow diagram illustrating the main processes involved in the system of FIG. 1;

FIG. 3 is a flowchart illustrating the steps involved in opening a data storage account in the system of FIG. 1;

FIGS. 4a to 4c are tables illustrating the format of data stored in the system of FIG. 1;

FIG. 5 is a block diagram showing a part of the system of FIG. 1, an ATM host, in more detail;

FIG. 6 is a block diagram illustrating different software agents executing on a part of the system of FIG. 1;

FIG. 7 is a block diagram illustrating computing systems of six different businesses interconnected to the brokerage system of FIG. 1; and

FIG. 8 is a block diagram of an alternative broker routine, implemented by a mobile agent.

### DETAILED DESCRIPTION

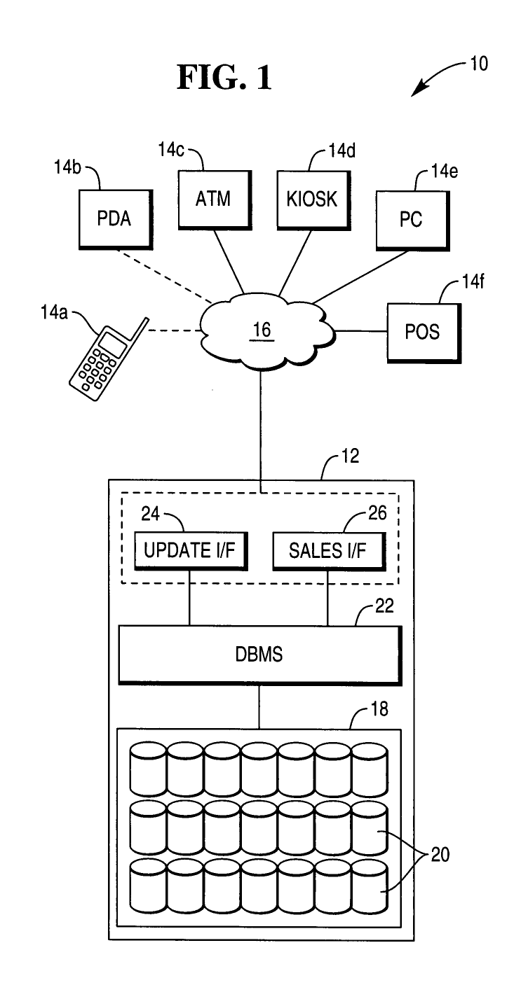

Reference is first made to FIG. 1, which shows a data collection, storage, and retrieval system 10. Data system 10 includes a data brokerage system 12 in communication with a plurality of computing devices 14 (six of which are shown in FIG. 1) via a network 16.

The brokerage system 12 is in the form of a data warehouse, such as the TOR (trade mark) system available from NCR Corporation, 1700 South Patterson Boulevard, Dayton, Ohio 45479-0001, USA.

The network 16 is a TCP/IP based network such as the Internet, which provides the World Wide Web facility.

The computing devices 14 can be any devices that support access to the network 16, and include: cellular telephones 14a, personal digital assistants 14b, ATM hosts 14c, kiosks 14d, personal computers 14e, and point of sale (PoS) terminals 14f.

The data warehouse 12 includes the conventional features of an object relational database management system (ORDBMS). These conventional features include: a data storage area 18 in the form of a large array of magnetic disk drives 20; and a database management system (DBMS) 22 that controls storage of data within, and extraction of data from, the data storage area 18.

The data warehouse 12 also includes a data update interface 24 and a data sales interface 26. Each of these interfaces 24,26 connects to the DBMS 22 and to the Internet 16. Although these interfaces 24,26 are shown separately in FIG. 1, in practical embodiments they would be implemented by a single application.

The update interface 24 is a Web-based application that receives data from a user via a Web browser on the network 16, and presents this data to the DBMS 22 for storing in the storage area 18.

The sales interface 26 is also a Web-based application, and receives requests for data from third parties and sends responses back to the third parties. When the sales interface receives a request for data, it generates queries that are conveyed to the DBMS 22 for fulfilling this request.

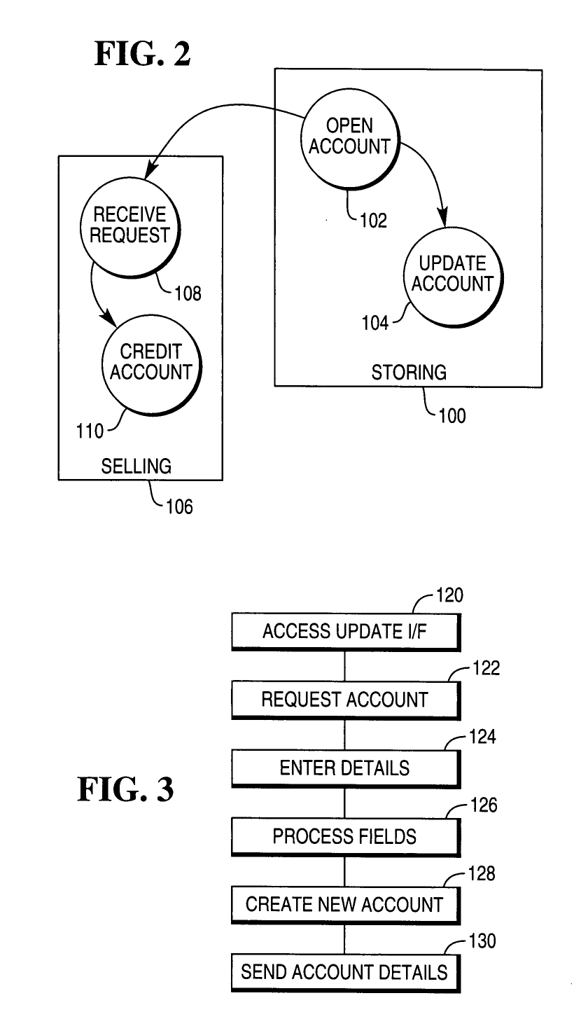

Reference is now made to FIG. 2, which is a process flow diagram illustrating the main processes involved in storing and brokering data in the data warehouse 12.

The first process is storing data (process 100). This process involves the sub-process of opening an account (process 102) which will be described in more detail below with reference to FIG. 3, and the sub-process of updating the account (process 104).

The other main process, which is initiated once an account has been opened and is executed concurrently with the updating process (process 104), is the selling process (process 106), whereby the data warehouse 12 attempts to sell data stored therein. The selling process (process 106) includes the sub-processes of receiving and fulfilling requests (process 108) and crediting the appropriate user accounts (process 110).

The process of opening an account will now be described in more detail, with reference to FIG. 3, which is a flowchart illustrating the steps involved.

A user opens a data storage account by accessing (step 120) the update interface 24, for example, by entering a URL associated with the update interface 24 in a Web browser executing on a home PC 14e.

The user then requests (step 122) a new data storage account. The update interface 24 provides the user with a Web-based form having data entry fields relating to user-specific data.

The user then enters (step 124) his/her user-specific data in the data entry fields provided on the Web page. The user-specific data typically includes the following.

(1) Contact details, such as the users: name, address, and telephone numbers.

(2) Personal details, such as the user's age, gender, date of birth, marital status, and such like.

(3) Financial details, such as the users: savings accounts, investments, shares, insurance policies, and such like.

(4) Lifestyle details, such as hobbies, interests, preferences, activities, and such like.

(5) Loyalty scheme details, such as frequent flier accounts, retail loyalty card accounts, car fuel accounts, and such like.

(6) Access rights details, which determines how much of the user's data a third party will be allowed to access. For example, one user may limit the access rights details to his lifestyle details and his loyalty scheme details. Another user may allow access to all of his details except his name and address.

The user-specific data also includes a list of user experiences (activities, events, transactions, and such like) that users typically record in their data accounts, and the user is invited to select those user experiences that they may wish to record.

The update interface 24 processes these fields (step 126) and creates records for inserting into a new account for the user.

The update interface 24 then requests (step 128) a new data storage account for that user, and sends the newly-created records for storing in the new account.

The DBMS 22 creates a new account (having an account identifier in the form of a series of numbers and letters) and stores the newly-created records in the data storage area 20.

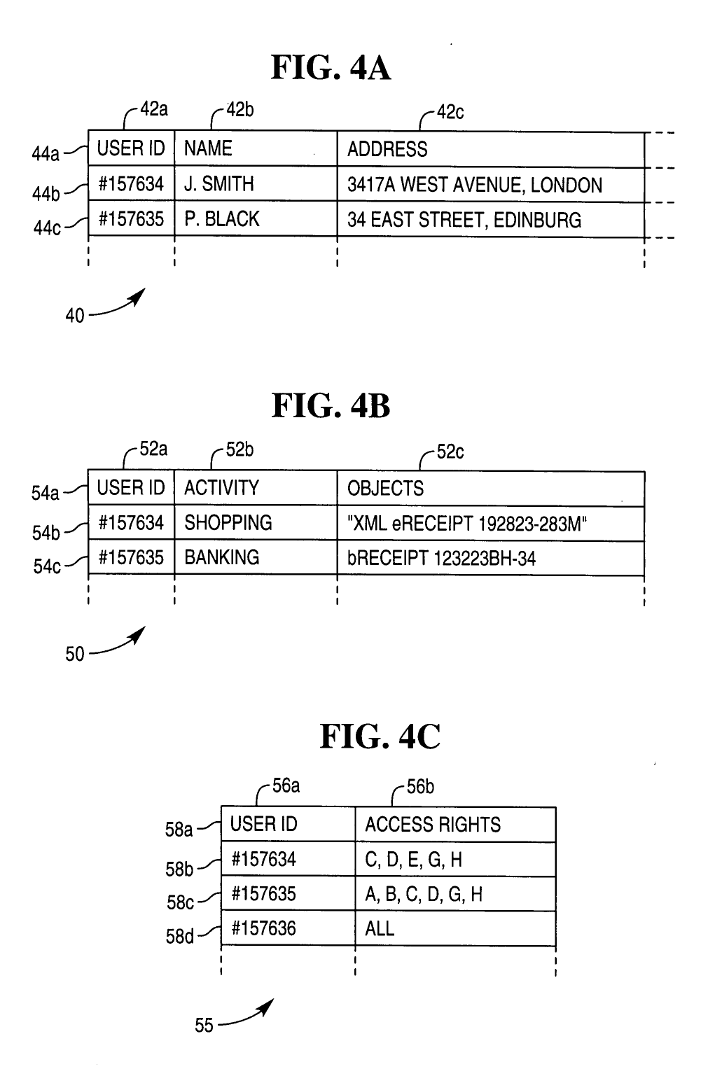

The DBMS 22 typically stores the data in tables, as illustrated in FIGS. 4a to 4c.

FIG. 4a shows a table 40 having multiple columns 42 (only three of which are shown in FIG. 4a for clarity) and multiple rows 44 (only three of which are shown in FIG. 4a for clarity). Apart from the header row 44a, each row 44b,c in the table 40 relates to a different data account, so that each entry in, for example, row 44b relates to the same user. The first column 42a contains the account identifier, the second column 42b contains the user's name, and the third column 42c contains the user's address. It will be appreciated that each of these multiple columns 42 contains an entry relating to the user-specific details of the user. The number of columns 42 provided depends on the number of user-specific fields that the user is asked to complete.

FIG. 4b shows a table 50 having three columns 52, and multiple rows 54 (only three of which are shown in FIG. 4b for clarity). The first column 52a stores the account identifier for a user, the second column 52b stores an activity type, for example “Shopping”, “Banking”, or such like, and the third column 52c stores objects (which may be text, images, sounds, or a combination of these). The number of rows 54 is related to the number of data accounts to be stored and the number of activities associated with each account.

The objects column 52c is suitable for storing digital shopping receipts, digital certificates (such as insurance certificates, driving license certificates, and such like).

FIG. 4c shows an access rights table 55 having two columns 56, and multiple rows 58 (only four of which are shown in FIG. 4c for clarity). The first column 56a stores the account identifier for a user, the second column 56b defines the access rights selected by that user. As shown in FIG. 4c, in this embodiment the access rights are referenced by letters, each letter relating to a particular field (such as the name field in column 42b, or the address field in column 42c). The number of rows 58 is related to the number of data accounts to be stored.

Referring again to FIG. 3, after requesting a new account, the update interface 24 then provides the user (step 130) with the account identifier and a password for accessing this new account.

When the user wishes to enter data into this account, the user provides this account identifier and password to gain access thereto.

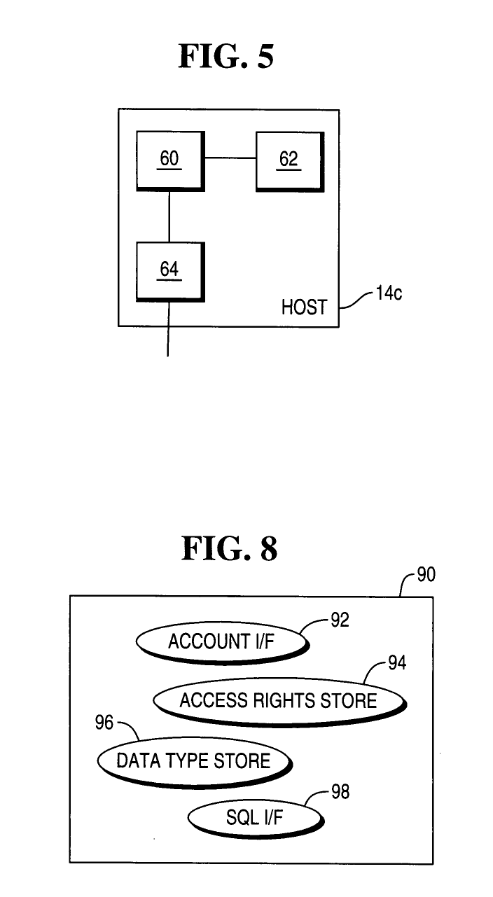

Referring now to FIG. 5, which shows the ATM host 14c in more detail, host 14c includes: an authorization facility 60; a back-office facility 62; and a client data update interface 64 for automatically transferring financial transaction data to the data update interface 24 via network 16. The client update interface 64 is in the form of an Open Financial Exchange (OFX) interface.

When a user (who has opened a data account on data warehouse 12) conducts a financial transaction at an ATM that is interconnected to ATM host 14c, then once the transaction has been executed, the OFX interface 64 in the ATM host 14c automatically sends the transaction details for that transaction to the data warehouse 12, together with the user's identifier. On receiving this transaction data, the DBMS 22 in the warehouse 12 updates the user's data account by adding this data into the objects field 52c (FIG. 4b).

When a user (who has opened a data account on data warehouse 12) conducts a retail transaction at a PoS terminal 14f (FIG. 1) in a retail outlet, then once the transaction has been completed, the PoS terminal 14f provides the user with a Web link to an electronic retail receipt. The receipt is in XML format and is stored on a Web server associated with the retail outlet. The user can then download this receipt, for example at a home PC, and then upload the receipt to the data warehouse 12 for storing in column 52c (FIG. 4b).

When a user (who has opened a data account on data warehouse 12) conducts a retail transaction at a retail outlet that does not support electronic receipts, the user can retain a paper copy receipt issued by the retail outlet. At some later stage, the user can enter the details of this receipt into a computing device 14 (FIG. 1), such as a home PC 14e, and upload the details to the data warehouse 12 by manually entering his identifier and password to gain access to his account.

Thus, it will be appreciated that the user's data account details can be updated automatically by a business (such as a retail outlet or financial institution), or manually by the user. This enables all different kinds of transactions, events, and activities to be captured and stored in the data warehouse 12 (FIG. 1).

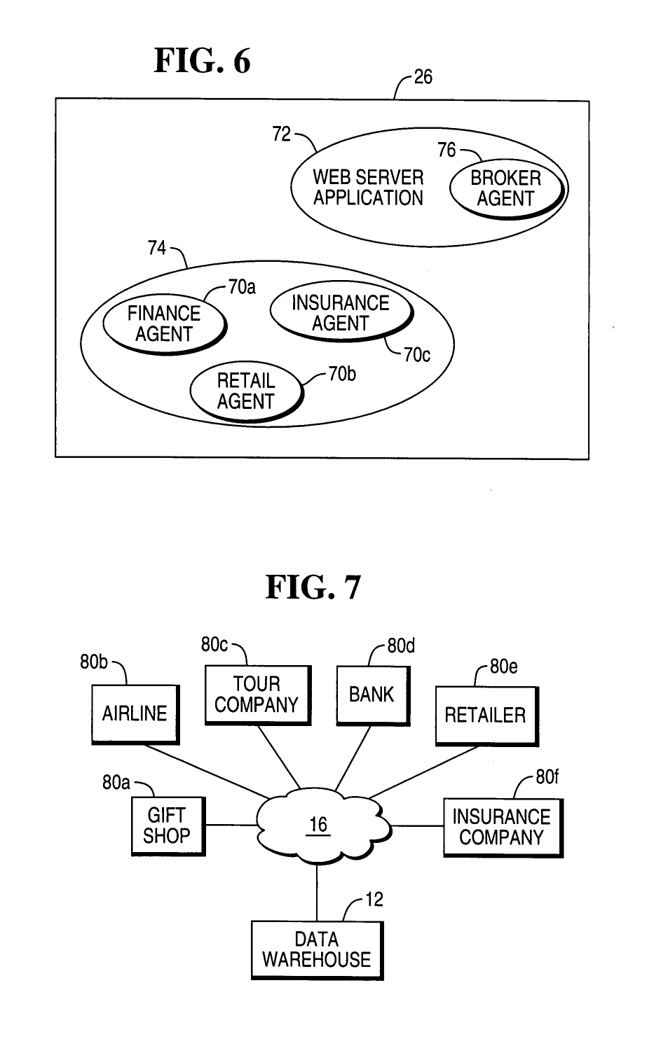

Referring to FIG. 6, in this embodiment, when a user opens a new account, the update interface 24 (FIG. 1) asks the user if he/she wishes to initiate one or more consumer software agents 70. If the user decides that he/she would like to have a consumer agent, then the update interface 24 instantiates a consumer agent 70 in the sales interface 26, and loads the agent 70 with the user-specific details from the appropriate row 44 of table 40 (FIG. 4a).

The agents 70 used in this embodiment are based on conventional intelligent agent infrastructures, such as the Aglets infrastructure. An Aglets Software Development Kit is available from IBM (trade mark).

Software agents are well known and are explained in, for example, “Developing Intelligent Agents for Distributed Systems: Exploring Architecture, Technologies, and Applications” by Michael Knapik and Jay B. Johnson, McGraw-Hill; ISBN: 0070350116.

The sales interface 26 includes a Web server application 72 and an agent handler 74 for receiving intelligent agents from the Internet 16, and for launching intelligent agents into the Internet 16. The agent handler 74 is implemented by software.

A consumer agent 70 may be a single entity that exists within the sales interface 26, and is activated, either periodically or in response to some consumer activity or event, to determine if there is any activity the consumer agent 70 might conduct that would be beneficial to the user for whom it acts. Alternatively the consumer agent 70 may be a series of small, dedicated, applications or agents that deal with specific consumer activities such as financial planning, shopping list generation, birthday card delivery, or such like. The user might also require the services of a specialized consumer agent to organize complex tasks such as insurance brokerage, travel agency and moving house.

The consumer agent 70 may take over the day to day running of the user's life, by doing the grocery shopping, arranging for parcel deliveries to be made at convenient times, getting the car serviced, and finding appropriate locations for a holiday for the user.

Regardless of how many consumer agents 70 are activated, the user sets the ground rules that determine how the agents 70 are allowed to act, and then abdicates responsibility for various tasks or chores.

A financial consumer agent 70a might offer a financial brokering service that would be able to deal with all incoming finances and outgoing payments. The financial agent 70a would arrange mortgages, loans, insurance, savings, pensions and eventually a consumer's entire financial portfolio.

Depending upon a user's financial state, employment position, and age, a financial consumer agent 70a might make suggestions as to applicable investments to make in pensions, life assurance and long term savings. The financial consumer agent 70a may obtain the quotes by “visiting” Web sites of financial institutions, insurance companies, and such like.

The financial consumer agent 70a might also deal with the day to day running of the user's finances, ensuring that sufficient funds exist in the user's current or checking account to cover outstanding payments by transferring funds from savings accounts as appropriate. As a large number of utility companies use direct debit from a bank account as the preferred method of bill payment, the financial consumer agent 70a may manage the flow of funds by monitoring the historical patterns of utility payments or through the use of electronic notification by the utility company of impending debits.

A financial consumer agent 70a could assess incoming credit card transactions to determine what portion of a bill should be paid immediately and what portion, if any, should be left outstanding. Such a decision might be based upon debt management, with day to day running expenses such as petrol and food purchases being paid off immediately while asset purchases such as furniture and major household goods are paid off over a series of months.

A financial consumer agent 70a would have all of the information necessary (because it can access the data account associated with the agent's user) to make and explain such decisions based on looking at the user's entire portfolio rather than just looking at individual payments in isolation.

A retail consumer agent 70b may be provided to assume the task of dealing with the supply of foodstuffs and household items on behalf of the user. By reviewing the user's food purchases stored within the data warehouse 12 (FIG. 1), a retail consumer agent 70b would be able to identify eating and purchasing patterns. The retail consumer agent 70b would also be able to suggest bulk purchases of canned and dry goods that could be staggered appropriately over time so that the user always has all the ingredients that they require without necessarily having a single annual delivery of an item of produce.

A retail consumer agent 70b may construct a shopping list of fresh foods for the user which could be e-mailed to the user prior to the user leaving their place of employment on their normal shopping days, thereby allowing the user to take this list to a store and select their own fruit and vegetables. At the same time as this happens, the list of canned and dried goods the user requires is marked off on their shopping list and communicated to a warehouse section of the store for preparation by staff. This provides the user with choice over controllable factors such as ripeness of fruit selected. The user is still able to make impulse purchases as he/she browses through the shop, and when the user reaches the check-out, his/her pre-selected purchases can be brought to him/her, pre-scanned into the system. The user only requires to have the personally selected purchases scanned before paying for all the purchases. An electronic receipt for these goods can then be e-mailed to the update interface 24 for updating the user's data account in the data warehouse.

Some agents may be provided that act when triggered by another event. For example, the approach of any significant anniversaries that are stored within the user's data account, such as the user's birthday, expiry of motor insurance, or the removal of penalty points from their driving license, could trigger an appropriate insurance consumer agent 70c to act on behalf of the user.

The insurance consumer agent 70c may query any available on-line insurance brokers providing only that amount of information required to obtain a quotation. The insurance consumer agent 70c would collate the results of quotations obtained from different insurers. The insurance consumer agent 70c may also use any other sources available, such as recommendation engines. The insurance consumer agent 70c would then provide its user with a small number of quotations with an appropriate combination of price and quality of service.

The sales interface 26 also has a broker routine 76, which is implemented as part of the Web server application 72.

Referring now to FIGS. 6 and 7, the broker 76 receives requests for information from third party businesses 80 (six of which are shown in FIG. 7). An insurance company 80f may wish to introduce a new financial product which it believes will be attractive to males aged between 23 and 30 who live in large cities.

A representative of the insurance company 80f can access the broker routine 76 (by entering a URL associated with the sales interface 26 in a Web browser) and transfer an acceptance criteria to the broker routine 76. The acceptance criteria includes a request for specific financial information relating to people having selected parameters, in this example, five hundred males aged between 23 and 30 and having an address in certain cities.

The broker routine 76 receives this request and queries the DBMS 22 to determine if the acceptance criteria can be met: that is, if there are sufficient user data accounts (500 data accounts) that meet the selected parameters and that have access rights that allow the DBMS 22 to divulge this information.

If there are not sufficient user data accounts then the broker routine 76 informs the insurance company via the company's Web browser that the request cannot be fulfilled. The broker routine 76 may offer the company 80f the number of data accounts that it has available (for example, 482 accounts that meet the parameters and that allow access to these parameters).

If there are sufficient user data accounts then the broker routine 76 informs the insurance company via the company's Web browser that the request can be fulfilled, and provides the insurance company with a charge for fulfilling the request. If the insurance company agrees to pay the charge then the broker routine 76 queries the DBMS 22 to obtain the information requested, and forwards the results of the query to the insurance company's Web browser.

The broker routine 76 then removes a service fee from this charge for administering the sale, and divides the remainder of the fee between the user data accounts that provided the information. Thus, each user data account that provided data is credited with a fee for participating.

At the end of a predetermined period, in this embodiment at the end of each calendar month, the broker routine 76 arranges for payment to be made to each user having a data account that has been credited during the month. The payment made to each user is the value of the credit applied to that user's data account.

The broker routine 76 may actively canvass for sale of the data in the data accounts. The broker routine 76 may send advertisements (for example, by email) to known businesses listed in business directories.

FIG. 8 is a block diagram of an alternative broker routine, implemented by a mobile agent. The agent 90 comprises means 92 for accessing a database storing a data account associated with an individual; means 94 for storing access rights selected by the individual; means 96 for notifying potential buyers about data that is available for accessing by the potential buyer; and means 98 for allowing a third party to query preselected data in return for payment. The access means 92 is in the form of an interface. The storing means 94 is a memory. The notifying means 96 includes a description of the type of user the data represents, for example, young affluent male, middle-aged lady who lives in a city, or such like. The means 98 for allowing queries is in the form of a standard interface for accessing a DBMS.

It will now be appreciated that this embodiment of the invention provides a data warehouse oriented to the needs of the consumer rather than the businesses—a consumer orientated data warehouse. The data warehouse uses data mining techniques and intelligent agents to acquire and manipulate the consumer's information to the ultimate advantage of the consumer. The data warehouse and agent infrastructure may be owned by either the consumers or a third party, and operated by a third party, trusted by the consumer to secure and manage their information appropriately and trusted by businesses to provide accurate and complete information when authorized to do so. The business model of the trusted third party involves the renting of data space and transaction processing time to consumers and the selling of approved consumer information to outside businesses (with both the trusted third party and the consumer receiving benefit from such transactions).

The core of this embodiment is a data warehouse in which is stored data associated with the activities, assets, liabilities, interests, preferences, personal information and contact points of an individual consumers. One way to store this information is in a relational database such as NCR's Teradata (trade mark) product, however, it is possible to go beyond a simple relational database to an Object Relational database such as NCR's Teradata Object Relational (TOR) system (trade mark). An Object Relational database provides for all the facilities of a relational database such as indexing, queries etc, but allows for more complex data types than can be used within a relational database. The consumer data warehouse could thus be any relational (RDBMS), object (ODBMS) or object relational (ORDBMS) data base management system or the like (such as those available from Oracle (trade mark), Sybase (trade mark), Informix (trade mark), DB2 (trade mark), Computer Associates (trade mark)).

The data warehouse continuously receives data from every activity and event that can be attributed to an individual consumer having a data account in the warehouse. Every financial transaction such as ATM withdrawals, salary deposits and bill payments may be mirrored into the data warehouse. Interfaces such as Open Financial Exchange (OFX) allow applications associated with the data warehouse to obtain the consumers transaction records automatically. Every retail transaction may be captured as the retailer can send the transaction receipt electronically in exchange for being allowed to hold a copy of this, incomplete, piece of the consumer's data as well as providing them with a saving on paper consumables. The consumers driving record, vehicle ownership and insurance history is similarly recorded in the data warehouse. Every time the consumer goes on holiday or on a business trip, details of the trip and their frequent flier status may be recorded. The data warehouse may also hold a calendar of forthcoming appointments, birthdays, holidays, and such like, as well as recording a history of these events. The consumer's assets (home, belongings) and liabilities (mortgage, loans) may also be recorded within the data warehouse.

The data warehouse therefore represents a complete record of all of the consumer's activities, interests, assets and liabilities. It can also store personal information and contact details (E-Mail, cellular telephone number, work and home telephone number, address) so that the data warehouse knows how the consumer can be contacted.

As the data warehouse is capable of completely representing all available information about individual consumers there is a huge opportunity for the consumer and the trusted third party to sell that information on to those businesses who currently do their data mining activities using their own, incomplete data sets. These businesses may want to interact directly with the data warehouse to get more complete information about consumers, and they may be prepared to pay for that privilege. A business might be considering introducing a new product or service and traditionally they would do market research by asking a cross section of consumers for their opinion.

The business model of the holder of the data may involve the consumer renting data space within the data warehouse and then paying for the use of agents. This can be provided through various levels of charging from a single per use charge for a brokering agent through a transaction cost model to a payment of the percentage of any savings made. The data warehouse may charge external businesses for individual reports or charge their agents (the external businesses' agents) on a per query basis; the data warehouse may even charge a business agent for access to its consumer agents to attempt to negotiate the supply of products and services to its consumer.

Various modifications may be made to the above described embodiment within the scope of the invention, for example, in other embodiments, the network may not be a TCP/IP network, or it may be an Intranet or Extranet. In other embodiments, a data storage account may be opened from a computing device other than a PC, for example, from a cellular telephone, a PDA, an ATM, or such like.

In other embodiments, different charging methods may be applied. For example, a user may pay a fixed regular charge as rent for the storage space in the data warehouse.

In other embodiments, when a third party pays for access to a user's data, the user may receive payment directly to his/her bank account, the details of which are held in the user's data account.

In other embodiments, a consumer sales agent may be provided to sell access to the user's data. In this type of embodiment, the user may instruct an intelligent agent to tout for business, by visiting sites of companies who may be interested in accessing the type of data held by the user.

In other embodiments, consumers may all become owners of the data warehouse (in a similar way to a co-operative society) and profit therefrom. Their level of ownership might be dependant upon the amount and quality of information that they store into the data warehouse.

What is claimed is:

1. A method of operating a data warehouse, the method comprising:
receiving from an individual a request to open a data storage account on the data warehouse;
providing to the individual data storage space of the data warehouse for use by the individual in response to receiving the request to open the data storage account;
receiving from the individual transactional data associated with transactions which have been conducted by the individual;
storing the transactional data received from the individual in the data storage space;
receiving from the individual access rights data which allows a determination to be made as to which portion of the stored transactional data can be accessed by a third party data user when the third party data user makes a request to access data in the data warehouse;
storing the access rights data received from the individual in the data storage space;
selling to the third party data user access to the individual's transactional data stored in the data storage space of the data warehouse;
receiving a request from the third party data user to access at least a portion of the individual's transactional data stored in the data storage space of the data warehouse;
determining if the individual's access rights data stored in the data storage space of the data warehouse allows the requested portion of the individual's transactional data to be accessed by the third party data user;
if the determination is in the affirmative, executing a query on the individual's transactional data stored in the data storage space of the data warehouse for the third party data user; and
charging either the individual or the third party data user, or both, for a result of the query.

2. A method according to claim 1, wherein receiving from an individual a request to open a data storage account comprises receiving the request over the Internet.

3. A method according to claim 1, further comprising providing the individual account identification and password information for accessing the data storage account.

4. A method according to claim 1, wherein the transactional data comprises at least some of:
contact details including name, address and telephone number of the individual;
personal details including age, gender, date of birth, and marital status of the individual;
financial details including saving account, investment, and insurance policy data of the individual;
lifestyle details including hobbies, interests, and activities of the individual; and
loyalty scheme details including frequent flyer account, retail loyalty card account, and car fuel account data of the individual.

5. A method according to claim 4, wherein the access rights data comprises instructions limiting access by a third party data user to one or more of the contact details, personal details, financial details, lifestyle details and loyalty scheme details of the individual, or any subsets thereof.

6. A method according to claim 1, wherein storing the transactional data comprises storing the transactional data as records in tables comprising one or more fields in the data storage space of the data warehouse.

7. A method according to claim 6, wherein the access rights data comprises data identifying one or more fields in the tables in the data storage space of the data warehouse a third party data user is allowed to access.

8. A method of operating a data warehouse, the method comprising:
receiving from an individual a request to open a data storage account on the data warehouse;
providing data storage space of the data warehouse for use by the individual in response to receiving the request to open the data storage account;
receiving from the individual transactional data associated with transactions which have been conducted by the individual;
storing the transactional data received from the individual in the data storage space;
receiving from the individual access rights data which allows a determination to be made as to whether a third party data user will be allowed to access the stored transactional data when the third party data user makes a request to access data in the data warehouse;
storing the access rights data received from the individual in the data storage space;
receiving a request from the third party data user to access at least a portion of the transactional data stored in the data storage space of the data warehouse;
determining if the access rights data allows the portion of the transactional data to be accessed;
if the determination is in the affirmative, executing a query on the data warehouse for the third party data user; and
charging both the individual and the third party data user for a result of the query.

9. A method of operating a data warehouse, the method comprising:
renting data storage space of the data warehouse to a first data provider;
renting data storage space of the data warehouse to a second data provider who is different from the first data provider;
receiving from the first data provider first transactional data associated with transactions conducted by the first data provider;
receiving from the second data provider second transactional data associated with transactions conducted by the second data provider;
storing the first transactional data received from the first data provider in the data storage space rented to the first data provider;
storing the second transactional data received from the second data provider in the data storage space rented to the second data provider;
receiving from the first data provider first access rights data which define how much of the stored first transactional data a third party data user will be allowed to access;
receiving from the second data provider second access rights data which define how much of the stored second transactional data a third party data user will be allowed to access;
storing the first access rights data received from the first data provider in the data storage space rented to the first data provider; and
storing the second access rights data received from the second data provider in the data storage space rented to the second data provider.

10. A method according to claim 9, further comprising:
receiving a request from the third party data user to access at least some of the transactional data stored in the rented data storage space of the data warehouse;
determining if either the first access rights data or the second access rights data, or both, allows the request from the third party data user; and
if the determination is in the affirmative, executing a query on the data warehouse for the third party data user in response to the request from the third party data user.

11. A method according to claim 10, further comprising:
charging the third party data user for a result of the query.
